(19) United States
(12) Patent Application Publication
(10) Pub. No.: US 2026/0328599 A1
(43) Pub. Date: Oct. 22, 2026

(54) End-to-End AI for fiber sensing: Eliminating intermediate processing via raw data learning

(71) Applicant: NEC Laboratories America, Inc., Princeton, NJ (US)

(72) Inventors: Zhuocheng Jiang, Plainsboro, NJ (US); Yue Tian, Princeton, NJ (US); Yuheng Chen, South Brunswick, NJ (US); Yangmin Ding, East Brunswick, NJ (US); Sarper Ozharar, Pennington, NJ (US); Ting Wang, West Windsor, NJ (US)

(21) Appl. No.: 19/632,407

(22) Filed: Mar. 30, 2026

Related U.S. Application Data
(60) Provisional application No. 63/792,356, filed on Apr. 22, 2025.

(51) Int. Cl. G01D 5/353; G01H 9/00

(52) U.S. Cl. CPC G01D 5/35358; G01H 9/004

(57) ABSTRACT

A system, method, and non-transitory computer-readable medium for end-to-end distributed fiber optic sensing are disclosed. The system bypasses traditional digital signal processing (DSP) modules by learning directly from raw 4-channel analog-to-digital converter (ADC) signals. The processing architecture includes a patch tokenizer configured to segment raw time-series signals into discrete patches and a channel encoder to identify signal origins. A Transformer module utilizing multi-head attention performs feature learning directly from the raw data, thereby eliminating fixed gauge length constraints and enabling variable gauge length learning. The end-to-end model achieves high recognition accuracy across complex environmental audio categories and is configured for downstream applications including acoustic recognition, anomaly detection, and infrastructure monitoring.

### CROSS REFERENCE TO RELATED APPLICATIONS

This application claims the benefit of U.S. Provisional Patent Application Ser. No. 63/792,356 filed Apr. 22, 2025, the entire contents of which is incorporated by reference as if set forth at length herein.

### FIELD OF THE INVENTION

The present disclosure relates generally to the field of distributed fiber optic sensing (DFOS), including distributed acoustic sensing (DAS) and distributed vibration sensing (DVS). More specifically, the disclosure relates to deep learning architectures and processing pipelines configured to interpret backscattered optical signals for event recognition, anomaly detection, and infrastructure monitoring.

### BACKGROUND OF THE INVENTION

The present disclosure relates generally to the field of distributed fiber optic sensing (DFOS), including distributed acoustic sensing (DAS) and distributed vibration sensing (DVS). More specifically, the disclosure relates to deep learning architectures and processing pipelines configured to interpret backscattered optical signals for event recognition, anomaly detection, and infrastructure monitoring.

Distributed fiber optic sensing has become a critical tool for large-scale monitoring of infrastructure, such as power grids, traffic routes, and telecommunications networks. These systems generally rely on analyzing the backscattered light—specifically Rayleigh backscatter—resulting from optical pulses launched into a sensing fiber.

Conventional sensing architectures utilize a multi-stage data processing pipeline to translate optical phenomena into actionable data. In such configurations, a first stage typically involves a digital signal processing (DSP) module that performs mathematical operations to extract intermediate features, such as phase differences or intensity variations. These intermediate features are then passed to a second stage, such as a separate machine learning model, for final analysis or classification.

This bifurcated approach introduces significant technical bottlenecks that remain unaddressed in the field. First, the intermediate DSP stage often relies on a fixed gauge length calculation. Because this parameter is hard-coded into the DSP algorithm, the system lacks the inherent flexibility to adapt its sensing resolution to different acoustic signatures or varying environmental conditions in real-time. Second, intermediate processing creates an information bottleneck. By filtering and condensing raw 4-channel analog-to-digital converter (ADC) signals into simplified phase or waterfall plots, nuanced high-fidelity data present in the original waveforms is permanently discarded. This loss of data integrity limits the precision of downstream recognition tasks. Furthermore, the computational overhead required to maintain separate DSP and machine learning stages increases system latency and physical hardware complexity.

There exists a significant unmet need for an end-to-end sensing architecture capable of bypassing traditional intermediate processing stages. Specifically, there is a need for a system configured to learn directly from raw ADC signals, thereby preserving the full informational content of the backscattered light and enabling variable gauge length learning within a unified neural network.

### SUMMARY OF THE INVENTION

The present disclosure provides a system, method, and non-transitory computer-readable medium for end-to-end distributed fiber optic sensing that bypasses traditional DSP modules by directly learning from raw analog-to-digital converter (ADC) signals.

According to a first aspect, a method for end-to-end distributed fiber optic sensing comprises receiving a set of raw 4-channel ADC signals from an optical receiver coupled to a sensing fiber. The set of raw 4-channel ADC signals is segmented into a plurality of signal patches using a patch tokenizer. Channel encoding is applied to each signal patch of the plurality of signal patches to identify a channel origin. The plurality of signal patches is processed through a Transformer model utilizing a multi-head attention mechanism to extract features directly from raw signal data, bypassing phase-extraction DSP stages. A sensing event is then classified based on the extracted features.

According to a second aspect, a distributed fiber optic sensing system comprises an optical hardware assembly configured to launch optical pulses into a sensing fiber and receive backscattered light. The system includes an optical hybrid and a plurality of balanced photodetectors configured to generate raw ADC signals from the backscattered light. A processor and a memory store an end-to-end machine learning model configured to tokenize the raw ADC signals into discrete embeddings, apply channel encoding to the discrete embeddings, and perform feature learning via a multi-head attention mechanism to identify a target event.

According to a third aspect, a non-transitory computer-readable medium stores instructions that perform a method comprising inputting raw 4-channel ADC signals comprising in-phase and quadrature channels. The raw 4-channel ADC signals are tokenized into a plurality of patches using a patch tokenizer window. Channel-specific origin information is encoded into each patch. Multi-head attention-based features are generated via a Transformer module configured to learn variable gauge length parameters, and a classification result is output for a downstream sensing application.

### BRIEF DESCRIPTION OF THE DRAWING

FIG. 1(A) and FIG. 1(B) are schematic diagrams showing an illustrative prior art uncoded and coded DFOS systems.

FIG. 2(A) is a schematic diagram showing an illustrative existing two-stage data processing pipeline for DFOS/DAS according to aspects of the present invention.

FIG. 2(B) is a schematic diagram showing an illustrative enhanced end-to-end data solution for DFOS according to aspects of the present invention.

FIG. 3(A) is a pseudocode listing of an illustrative Algorithm 1 that produces phase calculation from raw data according to aspects of the present invention.

FIG. 3(b) is a schematic block diagram illustrating a transformer design into which Algorithm 1 is incorporated according to aspects of the present invention.

FIG. 4 shows the classification performance on end to end model and performance comparisons against two-stage pipeline on 10-categories of classification in tabular form plots showing OTDR traces with and without VOA optical gain control according to aspects of the present disclosure.

FIG. 5 is a plot showing illustrative t-SNE visualization features from Transformer according to aspects of the present invention.

FIG. 6 is a schematic block diagram illustrating a computer system on which aspects or methods of the present invention may be implemented/executed according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

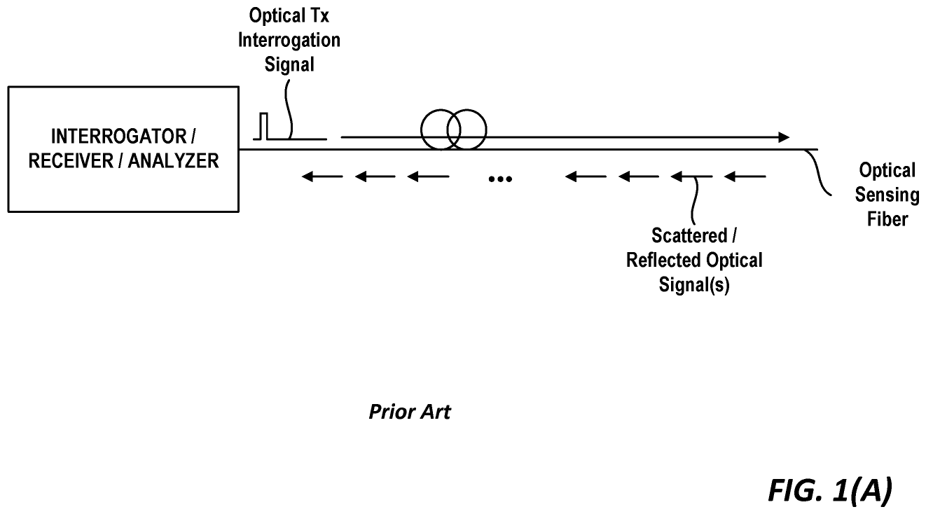

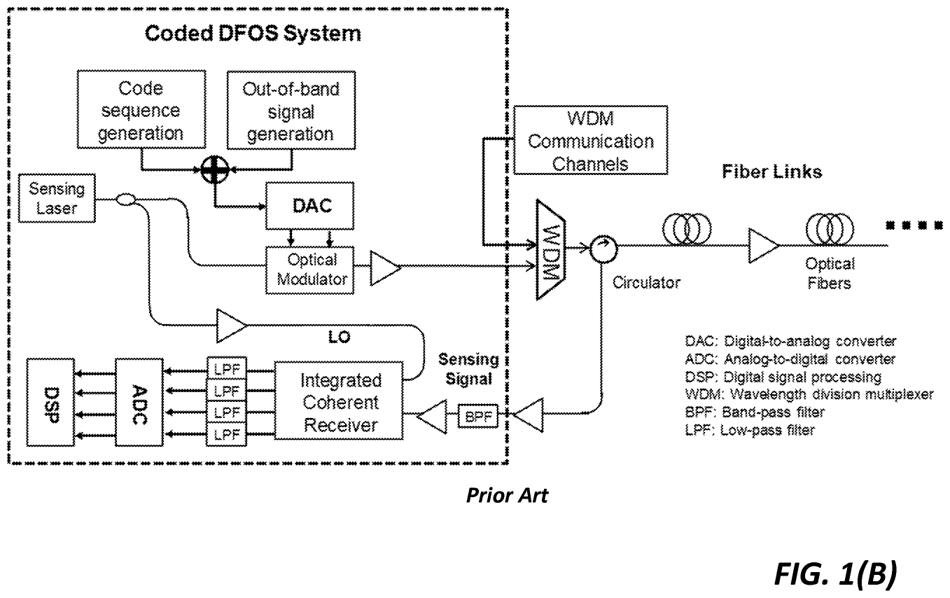

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

By way of some additional background, we note again that Distributed Acoustic Sensing (DAS) holds significant potential for detecting acoustic events within fiber optic networks. Traditional data analysis approaches typically rely on a two-stage processing pipeline, comprising a digital signal processing (DSP) module followed by a machine learning model. In this setup, the DSP extracts phase differences from the raw 4-channel ADC signals to generate intermediate features, which are then used for learning and analysis. In this work, we propose an end-to-end Al solution for DAS that bypasses the intermediate DSP stage by directly learning from raw ADC signals.

Our inventive approach describes an end-to-end Al solution for DAS that bypasses the intermediate DSP stage by directly learning from raw ADC signals. Our model eliminates the fix gauge length in DSP, and enables variable gauge length learning in designed Transformer model.

To demonstrate an end-to-end Al solution for fiber sensing that bypasses traditional DSP operations, we conducted data collection experiments by playing audio near the coil of a fiber optic cable, resulting in a dataset comprising 31 categories. Our proposed method achieves strong recognition accuracy on the collected dataset and outperforms the existing two-stage approach in comparative evaluations

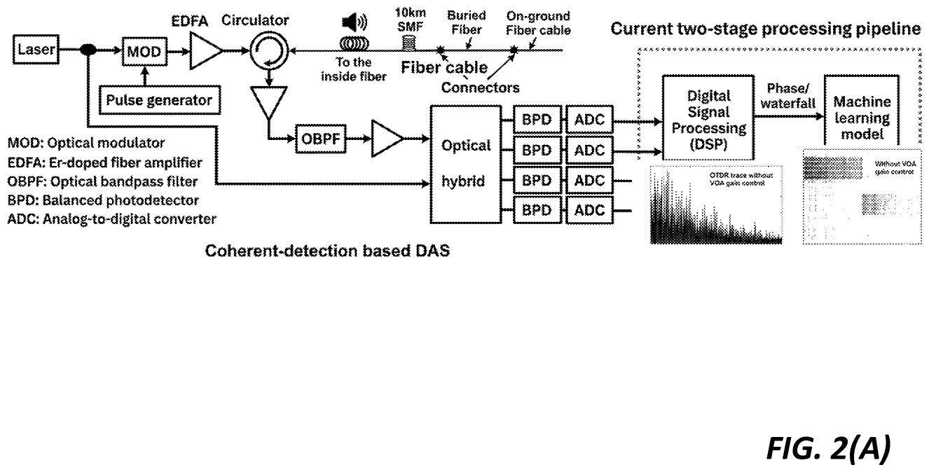

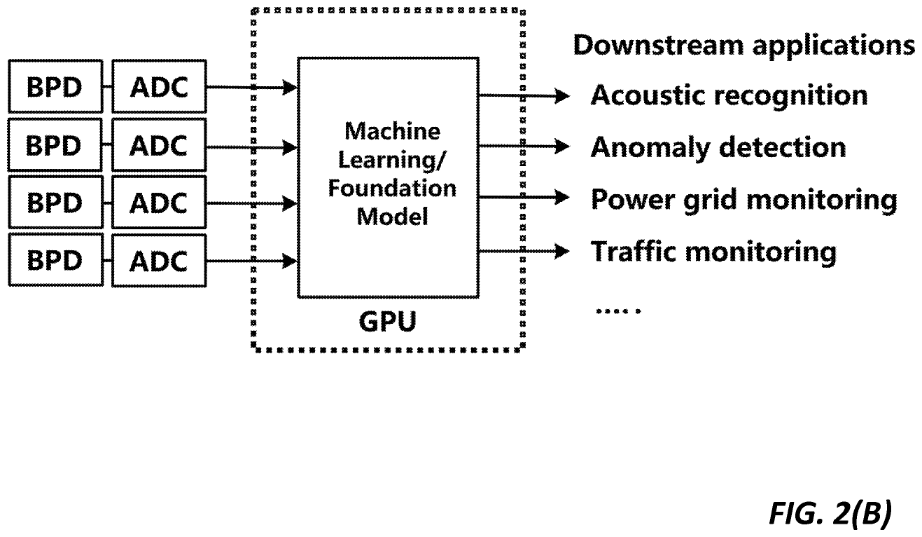

FIG. 2(A) is a schematic diagram showing an illustrative existing two-stage data processing pipeline for DFOS/DAS according to aspects of the present invention.

FIG. 2(B) is a schematic diagram showing an illustrative enhanced end-to-end data solution for DFOS according to aspects of the present invention.

As noted, the present invention provides an end-to-end artificial intelligence (AI) architecture that achieves unified, high-efficiency fiber sensing by eliminating intermediate digital signal processing (DSP) stages.

Referring to FIG. 2(B), an end-to-end processing architecture receives input from a coherent-detection based sensing setup. The optical hardware assembly comprises a laser source, an optical modulator driven by a pulse generator, an Erbium-doped fiber amplifier (EDFA), and an optical circulator coupled to a sensing fiber cable. Backscattered light returning from the sensing fiber is processed through an optical bandpass filter (OBPF), an optical hybrid, and a plurality of balanced photodetectors (BPD) to produce four raw analog-to-digital converter (ADC) signal channels: xᵢ, x_{q}, yᵢ, and y_{q}.

Specifically, the system acquires raw, 4-channel time-series data. These channels represent the in-phase (i) and quadrature (q) components of two orthogonal polarizations, outputting four distinct signals: xᵢ, x_{q}, yᵢ, and y_{q}. Unlike traditional two-stage systems that immediately convert these signals into phase data or waterfall plots via an intermediate DSP processor (as shown in FIG. 2(A)), the present architecture feeds the raw waveforms directly into an end-to-end machine learning foundation model executed on a graphics processing unit (GPU).

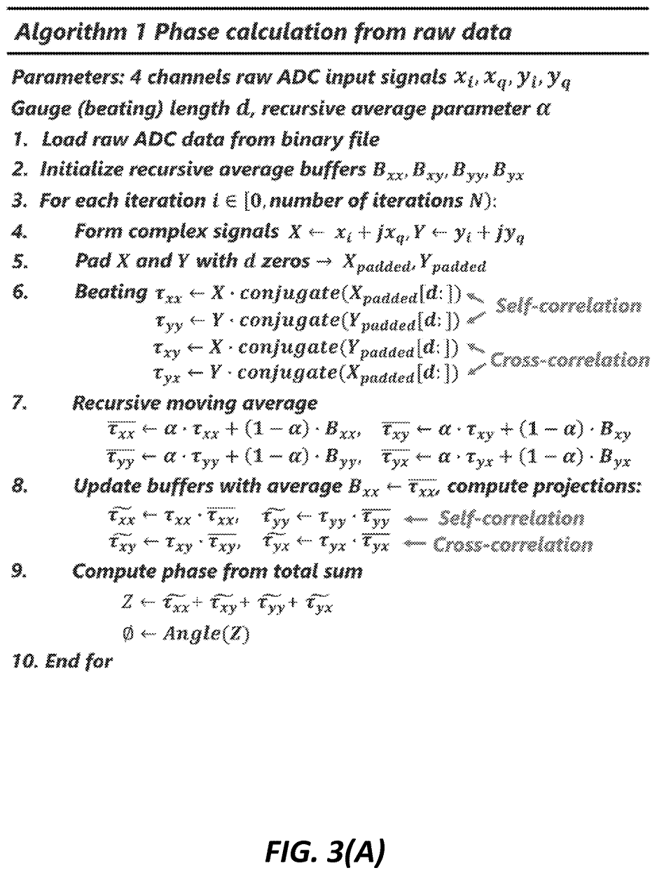

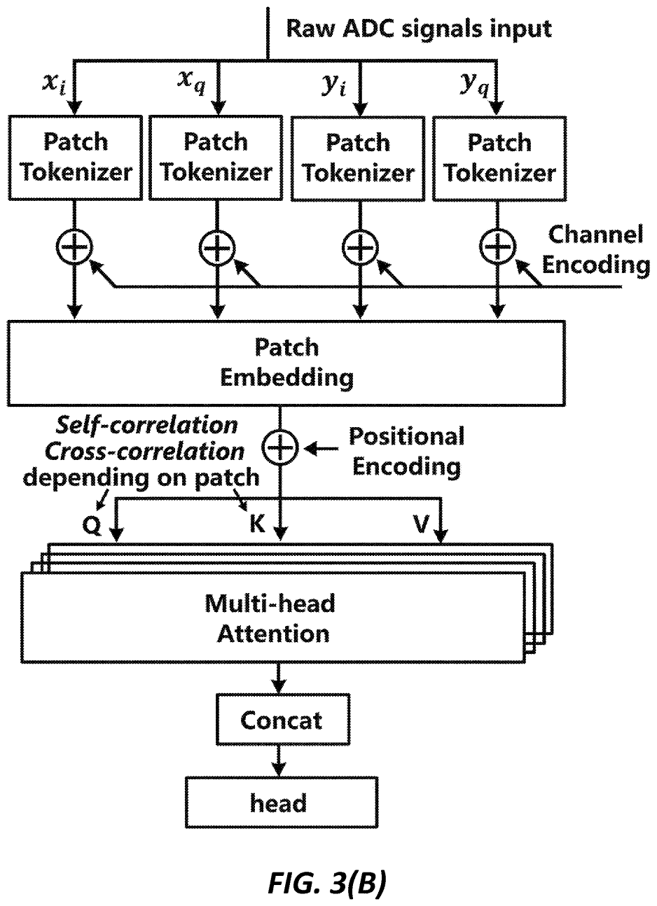

FIG. 3(A) is a pseudocode listing of an illustrative Algorithm 1 that produces phase calculation from raw data according to aspects of the present invention.

FIG. 3(b) is a schematic block diagram illustrating a transformer design into which Algorithm 1 is incorporated according to aspects of the present invention.

Unlike traditional systems that use a GPU to execute DSP for phase/waterfall extraction before feeding a separate ML model, the present invention utilizes a single-stage machine learning/foundation model. The model architecture replaces the mathematical self-correlation and cross-correlation steps of traditional phase calculation (shown in FIG. 3(A), Algorithm 1) with a learnable attention mechanism.

To process continuous raw signals using a Transformer-based architecture, the system employs a tokenization and encoding sequence.

### Patch Tokenization and Channel Encoding

First, a patch tokenizer segments the raw time-series into discrete patches. In a preferred embodiment, the tokenizer utilizes a window size of 25×25 data points. This dimensionality allows the model to capture localized temporal and spectral variations while maintaining computational efficiency.

Aspects of the patch tokenizer may be further defined as follows:

Windowing: For each of the four channels, the tokenizer segments the raw time-series into discrete patches using a window size of 25×25. This specific dimensionality allows the model to capture localized temporal and spectral variations while maintaining a manageable computational complexity for the attention mechanism.

Encoding: Following tokenization, Channel Encoding is incorporated into each patch. This step is critical as it indicates the specific channel origin (x vs. y polarization, i vs. q phase) of each patch, allowing the downstream attention mechanism to maintain spatial and polarimetric context.

Positional Encoding: Because Transformer models are inherently permutation-invariant, a positional encoding layer is applied to the patch embeddings to provide the model with a sense of the temporal order of the signal segments.

### Transformer Multi-Head Attention (MHA) Mechanism

The core engine of the system is the Transformer module, which utilizes a multi-head attention (MHA) mechanism to perform feature learning directly from the raw patches. The MHA mechanism evaluates relationships within the data using Query (Q), Key (K), and Value (V) matrices. The attention function is defined mathematically as:

$$A ( Q , K , V ) = Softmax ( \frac{{QK}^{T}}{\sqrt{{d}_{k}}} ) V$$

Where dₖ is the scaling factor based on the dimension of the keys.

Following tokenization, channel encoding is applied to the patches. This encoding is critical as it instructs the model regarding the specific channel origin (e.g., x versus y polarization) of each patch, allowing the downstream attention mechanism to maintain spatial and polarimetric context. Because Transformer models are inherently permutation-invariant, positional encoding is subsequently applied to the patch embeddings to provide the model with the temporal order of the signal segments.

At this point we note the following.

Replacing Traditional Correlation: In a traditional DSP pipeline, phase is calculated using complex self-correlation and cross-correlation iterations. In the present invention, these fixed mathematical operations are replaced by the learnable parameters of the Transformer's attention layers.

Variable Gauge Length Learning: Traditional DSP requires a fixed “gauge length” (d) to compute phase. The Transformer architecture enables “variable gauge length learning,” where the multi-head attention mechanism effectively “learns” the optimal physical distance over which to correlate signals based on the specific acoustic signature being processed.

### Integration and Downstream Head

As depicted in the architectural layout, the outputs from the multi-head attention layers are concatenated and passed to a final classification or “head” layer. This head is specifically trained for downstream tasks such as acoustic recognition, anomaly detection, or traffic monitoring. By bypassing the intermediate phase/waterfall extraction stage, the Transformer preserves nuanced waveform features that lead to the documented 96.50% recognition accuracy across 31 categories.

The system and method of the present invention provide high-fidelity recognition of diverse acoustic events by processing raw 4-channel ADC signals through a unified deep learning architecture. To evaluate the efficacy of the end-to-end model, data collection experiments were conducted by positioning an audio source near a fiber optic cable coil, resulting in a comprehensive dataset comprising 31 distinct categories of environmental audio recordings.

These 31 categories are broadly classified into five primary environmental groups to ensure robust performance across various field deployment scenarios:

Animal Sounds: This group includes diverse biological acoustic signatures used to train the model to differentiate between benign wildlife activity and potential security threats near the sensing fiber.

Natural Sounds: This category encompasses ambient environmental phenomena such as wind and rain. The end-to-end architecture enables the model to learn these broadband noise profiles directly, allowing it to effectively “ignore” background interference without requiring manual digital signal processing (DSP) adjustments.

Human Sounds: These categories focus on rhythmic or tonal patterns associated with human activity, which are critical for security and safety monitoring applications.

Indoor Sounds: This group demonstrates the system's versatility in facility-based environments, where the model learns to identify distinct mechanical or transient signatures from raw waveforms.

Urban Sounds: These categories involve complex, overlapping spectral profiles from vehicles, machinery, and urban infrastructure. The model's ability to learn from raw data enables it to maintain high accuracy in these high-interference environments, outperforming traditional two-stage processing pipelines. This group is vital for “Smart City” and traffic monitoring applications. Urban sounds typically involve complex, overlapping spectral profiles from machinery, vehicles, and infrastructure. The direct raw-data learning approach allows the system to outperform traditional two-stage pipelines in these high-interference environments.

The system achieved a peak recognition accuracy of 96.50% across the full 31-category dataset. Notably, the model maintained a stable accuracy profile (varying by only 0.38%) as the dataset expanded from 10 to 31 categories. This stability proves the scalability of the end-to-end approach, confirming that directly learning from raw ADC signals-bypassing intermediate DSP stages-enables the system to capture and retain high-dimensional features necessary for complex, real-world sensing tasks

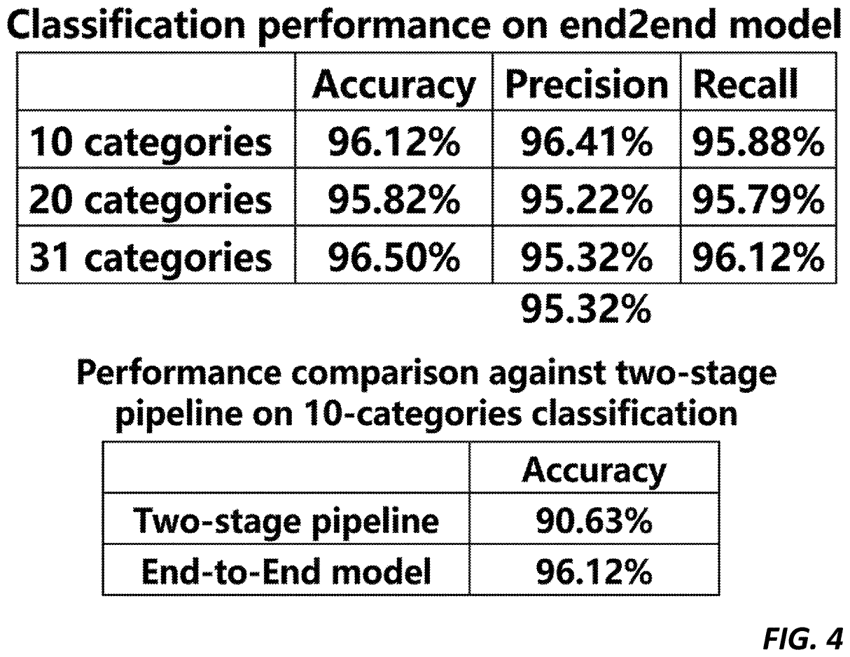

FIG. 4 shows the classification performance on end-to-end model and performance comparisons against two-stage pipeline on 10-categories of classification in tabular form plots showing OTDR traces with and without VOA optical gain control according to aspects of the present disclosure.

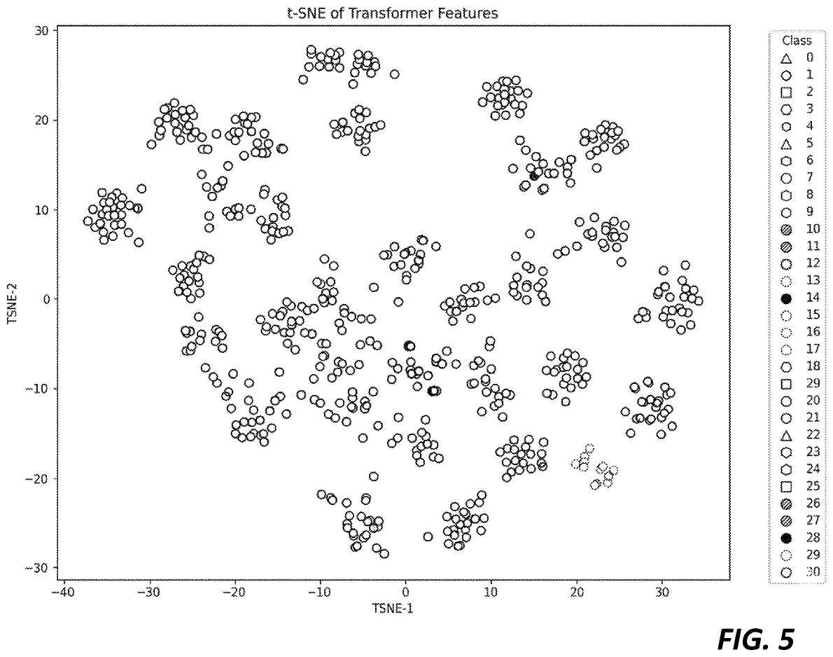

FIG. 5 is a plot showing illustrative t-SNE visualization features from Transformer according to aspects of the present invention.

As those skilled in the art will understand and appreciate, the t-SNE visualization (FIG. 5) confirms the model's ability to cluster all 31 classes with high precision, even as the number of categories increases. For the final application, we should specify that: i) the system achieved a 96.50% accuracy across all 31 categories; and ii) the transition from 10 to 31 categories showed no significant degradation in performance (only a 0.38% difference in accuracy), proving the architecture's scalability.

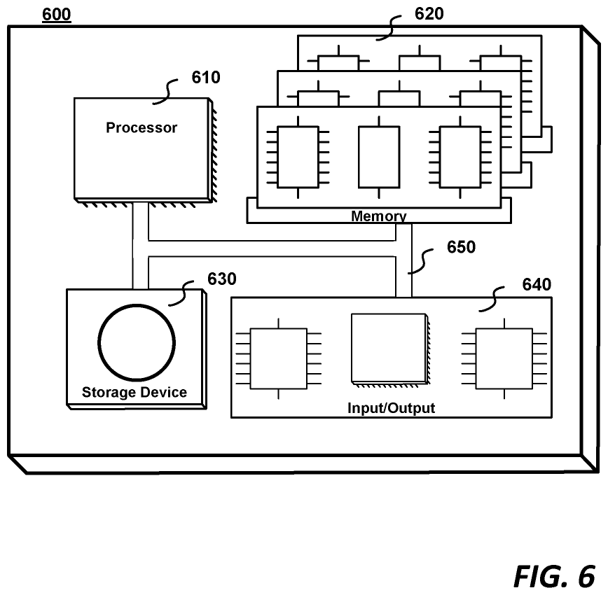

FIG. 6 is a schematic block diagram illustrating a computer system on which methods of the present invention may be implemented/executed.

With reference to that FIG. 6, there it shows an illustrative computer system, 600 suitable for implementing methods and systems according to an aspect of the present disclosure. As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 600 as stored program control instructions.

Computer system 600 includes processor 610, memory 620, storage device 630, and input/output structure 640. One or more input/output devices may include a display 645. One or more busses 650 typically interconnect the components, 610, 620, 630, and 640. Processor 610 may be a single or multi core. Additionally, the system may include accelerators etc further comprising the system on a chip.

Processor 610 executes instructions in which embodiments of the present disclosure may comprise steps described in one or more of the Drawing figures. Such instructions may be stored in memory 620 or storage device 630. Data and/or information may be received and output using one or more input/output devices.

Memory 620 may store data and may be a computer-readable medium, such as volatile or non-volatile memory. Storage device 630 may provide storage for system 600 including for example, the previously described methods. In various aspects, storage device 630 may be a flash memory device, a disk drive, an optical disk device, or a tape device employing magnetic, optical, or other recording technologies.

Input/output structures 640 may provide input/output operations for system 600.

At this point, those skilled in the art will understand that while we have presented our inventive concepts and description using specific examples, our invention is not so limited. Accordingly, the scope of our invention should be considered in view of the following claims.

1. A method for end-to-end distributed fiber optic sensing, comprising:
receiving a set of raw 4-channel analog-to-digital converter (ADC) signals from an optical receiver coupled to a sensing fiber;
segmenting the set of raw 4-channel ADC signals into a plurality of signal patches using a patch tokenizer;
applying channel encoding to each signal patch of the plurality of signal patches to identify a channel origin;
processing the plurality of signal patches through a Transformer model utilizing a multi-head attention mechanism to extract features directly from raw signal data; and
classifying a sensing event based on the extracted features.

2. The method of claim 1, wherein receiving the set of raw 4-channel ADC signals comprises inputting xᵢ, x_{q}, yᵢ, and y_{q} components of a backscattered optical field.

3. The method of claim 1, wherein processing the plurality of signal patches through the Transformer model bypasses a digital signal processing (DSP) stage configured for explicit phase extraction.

4. The method of claim 1, wherein the patch tokenizer utilizes a window size of 25×25 data points to segment time-series data into the plurality of signal patches.

5. The method of claim 1, wherein processing through the Transformer model further comprises performing variable gauge length learning via the multi-head attention mechanism.

6. The method of claim 1, further comprising applying positional encoding to a plurality of patch embeddings generated from the plurality of signal patches prior to processing through the Transformer model to maintain temporal context of the raw signal data.

7. The method of claim 1, wherein the sensing event is selected from a group consisting of: acoustic recognition, anomaly detection, power grid monitoring, and traffic monitoring.

8. A distributed fiber optic sensing system comprising:
an optical hardware assembly configured to launch optical pulses into a sensing fiber and receive backscattered light;
an optical hybrid and a plurality of balanced photodetectors configured to generate raw analog-to-digital converter (ADC) signals from the backscattered light; and
a processor and a memory, the memory storing an end-to-end machine learning model configured to:
tokenize the raw ADC signals into discrete embeddings;
apply channel encoding to the discrete embeddings; and
perform feature learning via a multi-head attention mechanism to identify a target event directly from the raw ADC signals.

9. The distributed fiber optic sensing system of claim 8, wherein the optical hardware assembly comprises an integrable tunable laser assembly (ITLA), a semiconductor optical amplifier (SOA), and an optical circulator.

10. The distributed fiber optic sensing system of claim 8, wherein the end-to-end machine learning model is configured to bypass mathematical self-correlation and cross-correlation equations executing on a secondary digital signal processor.

11. The distributed fiber optic sensing system of claim 8, wherein the end-to-end machine learning model is configured to achieve an acoustic recognition accuracy of at least 96 percent across at least 31 environmental audio categories.

12. The distributed fiber optic sensing system of claim 8, wherein the raw ADC signals comprise four distinct signal channels.

13. The distributed fiber optic sensing system of claim 8, wherein the multi-head attention mechanism is configured to evaluate relationships within the discrete embeddings utilizing Query, Key, and Value matrices to replicate signal beating operations.

14. The distributed fiber optic sensing system of claim 8, wherein the end-to-end machine learning model is a foundation model executed on a graphics processing unit (GPU).

15. A non-transitory computer-readable medium storing instructions that, when executed by a processor, perform a method comprising:
inputting raw 4-channel analog-to-digital converter (ADC) signals comprising xᵢ, x_{q}, yᵢ, and y_{q} channels;
tokenizing the raw 4-channel ADC signals into a plurality of patches using a patch tokenizer window;
encoding channel-specific origin information into each patch of the plurality of patches;
generating multi-head attention-based features via a Transformer module configured to learn variable gauge length parameters; and
outputting a classification result for a downstream sensing application.

16. The non-transitory computer-readable medium of claim 15, wherein the patch tokenizer window is sized at 25×25 data points.

17. The non-transitory computer-readable medium of claim 15, wherein the Transformer module performs multi-head attention to analyze signal correlations without a fixed gauge length constraint.

18. The non-transitory computer-readable medium of claim 15, wherein the encoded channel-specific origin information differentiates between in-phase and quadrature components of orthogonal polarizations.

19. The non-transitory computer-readable medium of claim 15, wherein generating multi-head attention-based features replaces a recursive moving average smoothing algorithm with dynamically learned attention weights.

20. The non-transitory computer-readable medium of claim 15, wherein the classification result comprises identification of at least one audio category selected from the group consisting of: animal sounds, natural sounds, human sounds, indoor sounds, and urban sounds.
